(19) United States
(12) Patent Application Publication
(10) Pub. No.: US 2011/0140034 A1
(43) Pub. Date: Jun. 16, 2011

(54) COMPOSITE FOR HEAT-DISSIPATING FILM

(76) Inventors: Chiang-Chung CHANG, Taipei City (TW); Chun-Ching HSIAO, Taipei City (TW)

(21) Appl. No.: 13/033,567

(22) Filed: Feb. 23, 2011

Related U.S. Application Data
(63) Continuation-in-part of application No. 12/547,510, filed on Aug. 26, 2009.

(51) Int. Cl. C09K 5/00

(52) U.S. Cl. 252/74

(57) ABSTRACT

A composite for coating and sputtering a heat-dissipating film, wherein composite contains silicon carbide, resin, and dilute solvent which are mixed and blended to be capable of being coated, sputtered, and cured into a heat-dissipating film of a specific thickness. As such, the heat-dissipating performance could be conveniently enhanced. here is no need to rely on heat-sinking fins of large surface area. The production cost is reduced, recycling is easier, and the highly contaminating anodizing treatment could be avoided, while the robustness against erosion and harsh weather is still maintained.

### CROSS-REFERENCE

This is a continuation-in-part of the co-pending patent application Ser. No. 12/547,510.

### TECHNICAL FIELD OF THE INVENTION

The present invention generally relates to a composite for coating and sputtering on an object for enhanced heat-dissipating performance so that there is no need to rely on heat-sinking fins of large surface area, the production cost is reduced, recycling is easier, and the highly contaminating anodizing treatment could be avoided without sacrificing the robustness against erosion and harsh weather.

### DESCRIPTION OF THE PRIOR ART

Computer processors, high-brightness light emitting diode (LED) circuit boards, and those having heat producing elements all require superior heat dissipation to maintain their normal operation. Conventionally, heat-sinking fins are installed on these heat producing elements to help heat dissipation. The heat-sinking fins and the heat producing elements are jointly referred to as “objects to be heat-dissipated.” Some may even have fans for additional ventilation. However, heat-sinking fins, as no power consumption is involved, are still the most popular means.

As the heat producing elements are getting more powerful, more heat is produced and the heat-sinking fins have to be bigger for increased surface area, making the product larger and heavier and contradicting the downsizing trend of electronic products.

Additionally, as some of the heat producing elements are for outdoor usage and are exposed directly to sun light and rain, and some are installed around salt marshes and hot spring and have to withstand the harsh environment. Therefore, for aluminum-made heat-sinking fins, they have to be further treated by anodizing anti-oxidation processing. However, anodizing treatment is not environment friendly, causing high production and waste processing cost.

### SUMMARY OF THE INVENTION

The invention provides a composite for coating and sputtering a heat-dissipating film. The composite contains silicon carbide of 67˜92 wt. % (weight percentage), powder resin of 8˜33 wt. %, and dilute ketones/alcohols-group material of 60˜65 wt. %. These components are mixed and blended to be capable of being coated, sputtered, and cured on the surface of an object to be heat-dissipated. According to experiment result, if sputtered on iron, the composite is able to achieve heat dissipation 20˜30 times better than baking varnish. In addition, the composite could be directly applied to aluminum and is able to achieve heat dissipation 10˜15 times better than aluminum of anodizing treatment. As such, there is no need to adopt heat-sinking fins of large surface area. The product therefore could be effectively downsized, conforming to the compactness trend of current product design. This is a major objective of the present invention.

Further more, the composite, after being sputtered and coated on the object to be heat-dissipated, is able to provide resistance to erosion and harsh weather. The conventional anodizing treatment therefore could be omitted and the production and recycling cost is significantly reduced. This is another objective of the present invention.

Additionally, to recycle a product coated with a heat-dissipating film made of the composite, there is no need to scrape and scrub the heat-dissipating film. When the product is burned in a furnace, due to the composite has different specific weight and material characteristics, the composite would be automatically separated and recovered. This is yet another objective of the present invention.

More importantly, the composite could be sputtered and coated on the surface of various metals (such as Fe, Al, Cu), various non-metallic materials (such as PP, PC, ABS), soft ceramic, various soft petroleum-based materials (such as acrylic, silicon), pure graphite, etc. In other words, the composite is widely applicable and, regardless the applied surface's shape and condition, the heat-dissipating performance could be easily enhanced. This is still another objective of the present invention.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the components of a composite for a heat-dissipating film according to the present invention.

FIG. 2 is a flow-chart diagram showing the process of manufacturing the composite of FIG. 1.

FIG. 3 is a flow-chart diagram showing the application of the composite of FIG. 1 on an object to be heat-dissipated.

FIG. 4 illustrates the relationship between the temperature and lighting time of a lamp coated with the present invention.

FIG. 5 illustrates the relationship between the heat conductivity and the particle diameter of the silicon carbide according to the present invention.

FIG. 6 illustrates the relationship between the heat conductivity and the amount of silicon carbide contained in the composite according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

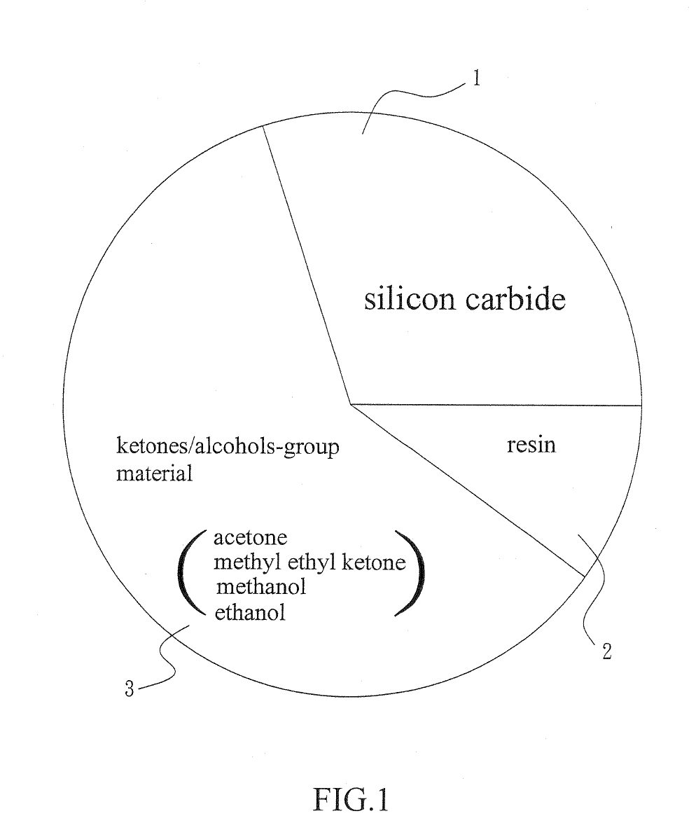

FIG. 1 is a schematic diagram showing the composition of a heat-dissipating film according to the present invention. As illustrated, the heat-dissipating film is made of a composite containing silicon carbide of 67˜92 wt. % (weight percentage), and powder resin of 8˜33 wt. %, wherein the silicon carbine is combined and blended with the resin powder, and then dried into a powder material for sputtering and coating on an object to be heat-dissipated, and the powder material is diluted with a solvent into required concentration when desired to sputter and coat on the object to be heat-dissipated.

According to a second preferred embodiment of the present invention, the composite contains a silicon carbide of 25˜30 wt. % and having a particle diameter of 5 μm˜50 μm, a resin of 10 wt. %, and a dilute solvent of 60˜65 wt. %, wherein the silicon carbide, the resin and the dilute solvent are combined and blended into a material capable of being sputtered, coated, and cured into a heat-dissipating film of a pre-determined thickness on an object to be heat-dissipate, and when in use, the material is sprayed on an object to be heat-dissipated by means of a spraying gun with a nozzle having a diameter of 1˜2 mm and then heated at 150˜170 degrees for 60˜30 minutes thereby forming a heat-dissipating film of a pre-determined thickness on an object to be heat-dissipated.

According to a third preferred embodiment of the present invention, the composite contains a silicon carbide of 25˜30 wt. % and having a particle diameter of 5 μm˜50 μm, a resin of 10 wt. %, and a dilute solvent of 60˜65 wt. %, wherein the silicon carbide, the resin and the dilute solvent are mixed and stirred into a sputtering material which is further diluted with the dilute solvent in an amount of at least one time as much as the sputtering material, and then dried at a temperature below 100 degrees centigrade into silicon carbide particles of a diameter of 5 μm˜50 μm coated with a film of resin for sputtering.

The foregoing composition is obtained from repeated experiments and the composite thus formed could be coated and cured on the surface of an object to be heat-dissipated into a heat-dissipating film for enhanced heat dissipation performance. With such a heat-dissipating film, there is no need to rely on heat-sinking fins of large surface area. Therefore, production cost is reduced, recycling is easier, and highly contaminating anodizing treatment is avoided without sacrificing the robustness against erosion and harsh weather.

The experiments are summarized in the following table:

| Major | | | | | |
|---|---|---|---|---|---|
| component | Percentage | Additives | Percentage | Outcome | Accepted |
| aluminum | 70 | PU resin | 10 | The major | No |
| nitride | | methanol | 20 | component | |
| | | | | deposits; caking is | |
| | | | | produced; the | |
| | | | | composite is | |
| | | | | sticky, cannot be | |
| | | | | stirred, and is not usable. | |
| aluminum | 30 | PU resin | 20 | The phenomenon | No |
| nitride | | toluene | 50 | of caking, | |
| | | | | stickiness, | |
| | | | | deposition is | |
| | | | | worse and the | |
| | | | | composite has | |
| | | | | unacceptable | |
| | | | | odor. | |
| aluminum | 30 | PU resin | 10 | Deposition still | No |
| nitride | | acetone | 60 | presents but the | |
| | | | | composite could | |
| | | | | be sputtered; | |
| | | | | however, there is | |
| | | | | too much wasted | |
| | | | | major component | |
| | | | | and no practical | |
| | | | | value. | |
| aluminum | 40 | PU resin | 10 | Deposition and | No |
| nitride | | methyl | 50 | caking are | |
| | | ethyl | | improved but the | |
| | | ketone | | composite still | |
| | | | | cannot be | |
| | | | | bucketed and | |
| | | | | sputtered and, if | |
| | | | | stored under room | |
| | | | | temperature, has | |
| | | | | the danger of | |
| | | | | evaporation. | |
| aluminum | 50 | PP | 10 | Components are | No |
| nitride | | methanol | 40 | not blended | |
| | | | | together and the | |
| | | | | composite is not | |
| | | | | usable. | |
| aluminum | 50 | PP | 10 | Components are | No |
| nitride | | acetone | 40 | not blended | |
| | | | | together and the | |
| | | | | composite is not | |
| | | | | usable. | |
| aluminum | 40 | PP | 10 | Components are | No |
| nitride | | methyl | 50 | not blended | |
| | | ethyl | | together and the | |
| | | ketone | | composite is not | |
| | | | | usable. | |
| aluminum | 50 | acrylicresin | 10 | Components are | No |
| nitride | | methanol | 40 | not blended | |
| | | | | together and the | |
| | | | | composite is not | |
| | | | | usable. | |
| aluminum | 60 | acrylic | 10 | The composite is | No |
| nitride | | acetone | 30 | sticky, has caking | |
| | | | | and low fluidness, | |
| | | | | and cannot be | |
| | | | | sputtered. | |
| aluminum | 50 | acrylic | 10 | The composite is | No |
| nitride | | methyl | 30 | sticky, has caking | |
| | | ethyl | | and low fluidness, | |
| | | ketone | | and cannot be | |
| | | | | sputtered. | |
| aluminum | 60 | silicon | 10 | Components are | No |
| nitride | | methanol | 40 | not blended | |
| | | | | together and the | |
| | | | | composite is not | |
| | | | | usable. | |
| aluminum | 70 | silicon | 10 | Components are | No |
| nitride | | acetone | 20 | not blended | |
| | | | | together and the | |
| | | | | composite is not | |
| | | | | usable. | |
| aluminum | 40 | silicon | 10 | Components are | No |
| nitride | | methyl | 50 | not blended | |
| | | ethyl | | together and the | |
| | | ketone | | composite is not | |
| | | | | usable. | |
| aluminum | 50 | epoxy | 10 | Components are | No |
| nitride | | methanol | 40 | not blended | |
| | | | | together and the | |
| | | | | composite is not | |
| | | | | usable. | |
| aluminum | 60 | epoxy | 10 | Components are | No |
| nitride | | acetone | 30 | not blended | |
| | | | | together and the | |
| | | | | composite is not | |
| | | | | usable. | |
| aluminum | 60 | epoxy | 10 | Components are | No |
| nitride | | methyl | 30 | not blended | |
| | | ethyl | | together and the | |
| | | ketone | | composite is not | |
| | | | | usable. | |
| aluminum | 60 | teflon | 10 | Components are | No |
| nitride | | methanol | 20 | not blended | |
| | | | | together and the | |
| | | | | composite is not | |
| | | | | usable. | |
| aluminum | 60 | teflon | 10 | Components are | No |
| nitride | | toluene | 30 | not blended | |
| | | | | together and the | |
| | | | | composite is not | |
| | | | | usable. | |
| aluminum | 70 | teflon | 10 | Deposition still | No |
| nitride | | acetone | 20 | presents but the | |
| | | | | composite could | |
| | | | | be sputtered; | |
| | | | | however, there is | |
| | | | | too much wasted | |
| | | | | major component | |
| | | | | and no practical | |
| | | | | value. | |
| aluminum | 50 | teflon | 10 | Deposition still | No |
| nitride | | methyl | 40 | presents but the | |
| | | ethyl | | composite could | |
| | | ketone | | be sputtered; | |
| | | | | however, there is | |
| | | | | too much wasted | |
| | | | | major component | |
| | | | | and no practical | |
| | | | | value. | |
| boron | 70 | PU | 10 | The major | No |
| nitride | | methanol | 20 | component | |
| | | | | deposits; caking is | |
| | | | | produced; the | |
| | | | | composite is | |
| | | | | sticky, cannot be | |
| | | | | stirred, and is not | |
| | | | | usable. | |
| boron | 60 | PU | 10 | The major | No |
| nitride | | toluene | 30 | component | |
| | | | | deposits; caking is | |
| | | | | produced; the | |
| | | | | composite is | |
| | | | | sticky, cannot be | |
| | | | | stirred, and is not | |
| | | | | usable. | |
| boron | 50 | PU | 10 | The major | No |
| nitride | | acetone | 40 | component's | |
| | | | | deposition is | |
| | | | | improved but the | |
| | | | | composite still | |
| | | | | cannot be | |
| | | | | bucketed and | |
| | | | | sputtered. | |
| boron | 50 | PU | 10 | The phenomenon | No |
| nitride | | methyl | 40 | of the major | |
| | | ethyl | | component's | |
| | | ketone | | deposition, | |
| | | | | stickiness, caking, | |
| | | | | and unable-to-stir | |
| | | | | is improved but | |
| | | | | the composite still | |
| | | | | cannot be | |
| | | | | bucketed and | |
| | | | | sputtered. | |
| boron | 60 | PU | 10 | Components are | No |
| nitride | | methanol | 30 | not blended | |
| | | | | together and the | |
| | | | | composite is not | |
| | | | | usable. | |
| boron | 60 | PP | 10 | The major | No |
| nitride | | toluene | 30 | component | |
| | | | | deposits; caking is | |
| | | | | produced; the | |
| | | | | composite is | |
| | | | | sticky, cannot be | |
| | | | | stirred, and is not | |
| | | | | usable. | |
| boron | 50 | PP | 10 | Deposition still | No |
| nitride | | acetone | 40 | presents but the | |
| | | | | composite could | |
| | | | | be sputtered; | |
| | | | | however, there is | |
| | | | | too much wasted | |
| | | | | major component | |
| | | | | and no practical | |
| | | | | value. | |
| boron | 50 | acrylic | 10 | Components are | No |
| nitride | | methanol | 40 | not blended | |
| | | | | together and the | |
| | | | | composite is not | |
| | | | | usable. | |
| boron | 50 | acrylic | 10 | The composite is | No |
| nitride | | toluene | 20 | sticky, has caking | |
| | | | | and low fluidness, | |
| | | | | and cannot be | |
| | | | | sputtered. | |
| boron | 70 | acrylic | 10 | The composite is | No |
| nitride | | acetone | 20 | sticky, has caking | |
| | | | | and low fluidness, | |
| | | | | and cannot be | |
| | | | | sputtered. | |
| boron | 40 | acrylic | 10 | Caking is still | No |
| nitride | | methyl | 50 | present but | |
| | | ethyl | | fluidness is | |
| | | ketone | | improved; and, | |
| | | | | even the | |
| | | | | composite is | |
| | | | | usable, it cannot | |
| | | | | be mass-produced. | |
| boron | 30 | silicon | 10 | Components are | No |
| nitride | | methanol | 60 | not blended | |
| | | | | together and the | |
| | | | | composite is not | |
| | | | | usable. | |
| boron | 40 | silicon | 10 | Components are | No |
| nitride | | acetone | 50 | not blended | |
| | | | | together and the | |
| | | | | composite is not | |
| | | | | usable. | |
| boron | 30 | silicon | 10 | The phenomenon | No |
| nitride | | toluene | 60 | of caking, | |
| | | | | stickiness, sinking | |
| | | | | is worse and the | |
| | | | | composite has | |
| | | | | unacceptable | |
| | | | | odor. | |
| boron | 30 | silicon | 10 | Caking is still | No |
| nitride | | methyl | 60 | present but | |
| | | ethyl | | fluidness is | |
| | | ketone | | improved; and, | |
| | | | | even the | |
| | | | | composite is | |
| | | | | usable, it cannot | |
| | | | | be mass-produced. | |
| boron | 70 | epoxy | 10 | Components are | No |
| nitride | | methanol | 20 | not blended | |
| | | | | together and the | |
| | | | | composite is not | |
| | | | | usable. | |
| boron | 70 | epoxy | 10 | The phenomenon | No |
| nitride | | toluene | 20 | of caking, | |
| | | | | stickiness, sinking | |
| | | | | is worse and the | |
| | | | | composite has | |
| | | | | unacceptable | |
| | | | | odor. | |
| boron | 40 | epoxy | 10 | Deposition still | No |
| nitride | | acetone | 50 | presents but the | |
| | | | | composite could | |
| | | | | be sputtered; | |
| | | | | however, there is | |
| | | | | too much wasted | |
| | | | | major component | |
| | | | | and no practical | |
| | | | | value. | |
| boron | 20 | epoxy | 10 | Deposition still | No |
| nitride | | methyl | 70 | presents but the | |
| | | ethyl | | composite could | |
| | | ketone | | be sputtered; | |
| | | | | however, there is | |
| | | | | too much wasted | |
| | | | | major component | |
| | | | | and no practical | |
| | | | | value. | |
| boron | 70 | teflon | 10 | Components are | No |
| nitride | | methanol | 20 | not blended | |
| | | | | together and the | |
| | | | | composite is not | |
| | | | | usable. | |
| boron | 40 | teflon | 10 | The major | No |
| nitride | | toluene | 50 | component | |
| | | | | deposits; caking is | |
| | | | | produced; the | |
| | | | | composite is | |
| | | | | sticky, cannot be | |
| | | | | stirred, and is not | |
| | | | | usable. | |
| boron | 20 | teflon | 10 | Deposition still | No |
| nitride | | acetone | 70 | presents but the | |
| | | | | composite could | |
| | | | | be sputtered; | |
| | | | | however, there is | |
| | | | | too much wasted | |
| | | | | major component | |
| | | | | and no practical | |
| | | | | value. | |
| boron | 40 | teflon | 10 | The major | No |
| nitride | | methyl | 50 | component | |
| | | ethyl | | deposits; caking is | |
| | | ketone | | produced; the | |
| | | | | composite is | |
| | | | | sticky, cannot be | |
| | | | | stirred, and is not | |
| | | | | usable. | |
| silicon | 20 | PU | 10 | The composite is | No |
| carbide | | methanol | 70 | better than the | |
| | | | | previous one but | |
| | | | | still cannot be | |
| | | | | bucketed and | |
| | | | | sputtered and, if | |
| | | | | stored under room | |
| | | | | temperature, has | |
| | | | | the danger of | |
| | | | | evaporation. | |
| silicon | 10 | PU | 10 | Deposition still | No |
| carbide | | acetone | 80 | presents but the | |
| | | | | composite could | |
| | | | | be sputtered; | |
| | | | | however, there is | |
| | | | | too much wasted | |
| | | | | major component | |
| | | | | and no practical | |
| | | | | value. | |
| silicon | 10 | PP | 10 | The major | No |
| carbide | | methanol | 80 | component | |
| | | | | deposits; caking is | |
| | | | | produced; the | |
| | | | | composite is | |
| | | | | sticky, cannot be | |
| | | | | stirred, and is not | |
| | | | | usable. | |
| silicon | 10 | PP | 10 | The phenomenon | No |
| carbide | | toluene | 80 | of caking, | |
| | | | | stickiness, sinking | |
| | | | | is worse and the | |
| | | | | composite has | |
| | | | | unacceptable | |
| | | | | odor. | |
| silicon | 30 | acrylic | 10 | The composite is | No |
| carbide | | methanol | 60 | better than the | |
| | | | | previous one but | |
| | | | | still cannot be | |
| | | | | bucketed and | |
| | | | | sputtered and, if | |
| | | | | stored under room | |
| | | | | temperature, has | |
| | | | | the danger of | |
| | | | | evaporation. | |
| silicon | 50 | silicon | 10 | The components | No |
| carbide | | toluene | 40 | are effectively | |
| | | | | blended but | |
| | | | | deposition is | |
| | | | | obvious; and the | |
| | | | | composite has to | |
| | | | | be further worked | |
| | | | | by continuous | |
| | | | | shaking, | |
| | | | | increasing the | |
| | | | | production | |
| | | | | difficulty | |
| silicon | 50 | silicon | 10 | The components | No |
| carbide | | acetone | 40 | begin to dissolve | |
| | | | | but there is highly | |
| | | | | sticky caking | |
| | | | | whose | |
| | | | | concentration is | |
| | | | | too high to | |
| | | | | decompose. | |
| silicon | 10 | epoxy | 10 | The major | No |
| carbide | | methanol | 80 | component | |
| | | | | deposits; caking is | |
| | | | | produced; the | |
| | | | | composite is | |
| | | | | sticky, cannot be | |
| | | | | stirred, has bad | |
| | | | | odor, and is not | |
| | | | | usable. | |
| silicon | 30 | epoxy | 10 | Caking is still | Close to |
| carbide | | methyl | 60 | present but | be |
| | | ethyl | | fluidness is | accepted |
| | | ketone | | improved; and, | |
| | | | | even the | |
| | | | | composite is | |
| | | | | usable, it cannot | |
| | | | | be | |
| | | | | mass-produced; | |
| | | | | the composite has | |
| | | | | bad odor and | |
| | | | | probably cannot | |
| | | | | pass examination; | |
| | | | | however, the | |
| | | | | composite could | |
| | | | | be actually | |
| | | | | applied by | |
| | | | | sputtering despite | |
| | | | | a weak adhesion | |
| | | | | and more | |
| | | | | suspended | |
| | | | | matters. | |

From the last experiment, the following conclusion could be drawn:
1. Silicon carbide has the highest feasibility as the major component.
2. Compared to other experimented major components, there are more and stable sources and suppliers for silicon carbide, and therefore the composite's cost is more controllable.
3. To enhance the decomposition of suspended matters and adhesion strength of sputtering, more extensive analysis has to be conducted so as to increase the stability of the composite's manufacturing.
4. The most important issue is how well silicon carbide is integrated with high-level resin and whether heat conductivity could be continuously maintained after sputtering.
5. Additional components are required to achieve uniform coating without causing accumulated spots.
6. Numerous dissolvents for chemical combination are available and those that are hazardous could be avoided for enhanced safety.
7. The major component is easy to obtain and there is no concern over shortage or monopoly.
   Accordingly, additional experiments are conducted and summarized in the following table:

| Major | | | | | |
|---|---|---|---|---|---|
| component | Percentage | Additives | Percentage | Outcome | Accepted |
| silicon | 67 | powder | 33 | There are | OK |
| carbide | | resin | | extraneous | |
| | | | | suspended matters | |
| | | | | but, if well | |
| | | | | shaken, the | |
| | | | | composite's | |
| | | | | adhesion is not | |
| | | | | affected; the | |
| | | | | composite | |
| | | | | evaporates faster | |
| | | | | but has feasible | |
| | | | | adhesion; the | |
| | | | | composite seems | |
| | | | | satisfactory yet | |
| | | | | the adhesion is not uniform | |
| | | | | as spots are present. | |
| silicon | 92 | powder | 8 | There are | OK |
| carbide | | resin | | extraneous | |
| | | | | suspended matters | |
| | | | | but, if well | |
| | | | | shaken, the | |
| | | | | composite's | |
| | | | | adhesion is not | |
| | | | | affected; the | |
| | | | | composite | |
| | | | | evaporates faster | |
| | | | | but has feasible | |
| | | | | adhesion; the | |
| | | | | composite seems | |
| | | | | satisfactory yet | |
| | | | | the adhesion is not | |
| | | | | uniform as spots | |
| | | | | are present; and, | |
| | | | | up to now, it | |
| | | | | seems that spots | |
| | | | | are standard | |
| | | | | phenomenon. | |
| silicon | 30 | teflon | 9-11 | There are | OK |
| carbide | | methyl | 60 | extraneous | |
| | | ethyl | | suspended matters | |
| | | ketone | | but, if well | |
| | | | | shaken, the | |
| | | | | composite's | |
| | | | | adhesion is not | |
| | | | | affected; the | |
| | | | | composite | |
| | | | | evaporates faster | |
| | | | | but has feasible | |
| | | | | adhesion; the | |
| | | | | composite seems | |
| | | | | satisfactory yet | |
| | | | | the adhesion is not | |
| | | | | uniform as spots | |
| | | | | are present. | |
| silicon | 30 | teflon | 9-11 | There are | OK |
| carbide | | methyl | 60 | extraneous | |
| | | ethyl | | suspended matters | |
| | | ketone | | but, if well | |
| | | | | shaken, the | |
| | | | | composite's | |
| | | | | adhesion is not | |
| | | | | affected; the | |
| | | | | composite | |
| | | | | evaporates faster | |
| | | | | but has feasible | |
| | | | | adhesion; the | |
| | | | | composite seems | |
| | | | | satisfactory yet | |
| | | | | the adhesion is not | |
| | | | | uniform as spots | |
| | | | | are present; and, | |
| | | | | up to now, it | |
| | | | | seems that spots | |
| | | | | are standard | |
| | | | | phenomenon. | |
| silicon | 30 | teflon | 9-11 | There are | OK |
| carbide | | acetone | 30 | extraneous | |
| | | methyl | 30 | suspended matters | |
| | | ethyl | | but, if well | |
| | | ketone | | shaken, the | |
| | | | | composite's | |
| | | | | adhesion is not | |
| | | | | affected; the | |
| | | | | composite | |
| | | | | evaporates faster | |
| | | | | but has feasible | |
| | | | | adhesion; the | |
| | | | | composite seems | |
| | | | | satisfactory yet | |
| | | | | the adhesion is not | |
| | | | | uniform as spots | |
| | | | | are present; and, | |
| | | | | up to now, it | |
| | | | | seems that spots | |
| | | | | are standard | |
| | | | | phenomenon; | |
| | | | | ionizing state is | |
| | | | | more obvious and | |
| | | | | distribution is | |
| | | | | more uniform | |
| | | | | with no | |
| | | | | deposition; using | |
| | | | | a single dissolvent | |
| | | | | would have even | |
| | | | | better effect with | |
| | | | | enhanced | |
| | | | | volatility; | |
| | | | | however, lack of | |
| | | | | film thickness is | |
| | | | | still an issue. | |
| silicon | 30 | teflon | 9-11 | There are | OK |
| carbide | | acetone | 25 | extraneous | |
| | | methyl | 30 | suspended matters | |
| | | ethyl | | but, if well | |
| | | ketone | | shaken, the | |
| | | methanol | 10 | composite's | |
| | | | | adhesion is not | |
| | | | | affected; the | |
| | | | | composite | |
| | | | | evaporates faster | |
| | | | | but has feasible | |
| | | | | adhesion; the | |
| | | | | composite seems | |
| | | | | satisfactory yet | |
| | | | | the adhesion is not | |
| | | | | uniform as spots | |
| | | | | are present; and, | |
| | | | | up to now, it | |
| | | | | seems that spots | |
| | | | | are standard | |
| | | | | phenomenon; | |
| | | | | ionizing state is | |
| | | | | more obvious and | |
| | | | | distribution is | |
| | | | | more uniform | |
| | | | | with no | |
| | | | | deposition; using | |
| | | | | a single dissolvent | |
| | | | | would have even | |
| | | | | better effect with | |
| | | | | enhanced | |
| | | | | volatility; | |
| | | | | however, lack of | |
| | | | | film thickness is | |
| | | | | still an issue; the | |
| | | | | ionizing state is | |
| | | | | even more evident | |
| | | | | after adding | |
| | | | | methanol; the | |
| | | | | uniformity of | |
| | | | | particle sputtering | |
| | | | | is improved with | |
| | | | | even better | |
| | | | | volatility; gaps | |
| | | | | between particles | |
| | | | | and film thickness | |
| | | | | are stable; there is | |
| | | | | no non-uniformity | |
| | | | | problem; | |
| | | | | however, the | |
| | | | | volatility of | |
| | | | | methanol could be | |
| | | | | dangerous. | |
| silicon | 30 | teflon | 9-11 | There are | |
| carbide | | acetone | 25 | extraneous | |
| | | methyl | 30 | suspended matters | |
| | | ethyl | | but, if well | |
| | | ketone | | shaken, the | |
| | | ethanol | 10 | composite's | |
| | | | | adhesion is not | |
| | | | | affected; the | |
| | | | | composite | |
| | | | | evaporates faster | |
| | | | | but has feasible | |
| | | | | adhesion; the | |
| | | | | composite seems | |
| | | | | satisfactory yet | |
| | | | | the adhesion is not | |
| | | | | uniform as spots | |
| | | | | are present; and, | |
| | | | | up to now, it | |
| | | | | seems that spots | |
| | | | | are standard | |
| | | | | phenomenon; | |
| | | | | ionizing state is | |
| | | | | more obvious and | |
| | | | | distribution is | |
| | | | | more uniform | |
| | | | | with no | |
| | | | | deposition; using | |
| | | | | a single dissolvent | |
| | | | | would have even | |
| | | | | better effect with | |
| | | | | enhanced | |
| | | | | volatility; | |
| | | | | however, lack of | |
| | | | | film thickness is | |
| | | | | still an issue; the | |
| | | | | ionizing state is | |
| | | | | even more evident | |
| | | | | after adding | |
| | | | | methanol; the | |
| | | | | uniformity of | |
| | | | | particle sputtering | |
| | | | | is improved with | |
| | | | | even better | |
| | | | | volatility; gaps | |
| | | | | between particles | |
| | | | | and film thickness | |
| | | | | are stable; there is | |
| | | | | no non-uniformity | |
| | | | | problem; | |
| | | | | however, the | |
| | | | | volatility of | |
| | | | | methanol could be | |
| | | | | dangerous; | |
| | | | | however, there is | |
| | | | | no volatile gas | |
| | | | | that would be | |
| | | | | hazardous to | |
| | | | | human. | |
| silicon | 25 | teflon | 9-11 | For repeated | OK |
| carbide | | acetone | 25 | applications for | |
| | | methyl | 30 | 20 times, the | |
| | | ethyl | | result is stable and | |
| | | ketone | | there is no | |
| | | ethanol | 10 | non-uniform | |
| | | | | sputtering. | |

Up to now, the composition of the composite is determined.

From the above experiments, the ketones/alcohols-group material 3 could be a composite of acetone, methyl ethyl ketone, methanol, and ethanol of appropriate amounts. The composite is then added and blended into the silicon carbide 1 to obtain a coating composite for sputtering onto an object to be heat-dissipated for enhanced heat dissipation. Up to the present time, coating with silicon carbide 1 having particle diameter of 5 μm˜50 μm has been successfully developed. To satisfy the requirement for a specific color, after repeated experiments, the present inventor found that gemstone powders could be optionally added and, by the interaction between the gemstone powders and the major component, the composite of a specific color could be achieved. In other words, the added gemstone powders are mainly used for mixing and fixing colors without sacrificing the heat conductivity. Therefore, depending on the color requirement, gemstone powders of appropriate amount could be added. The percentage of the gemstone powders could affect the shading of the color.

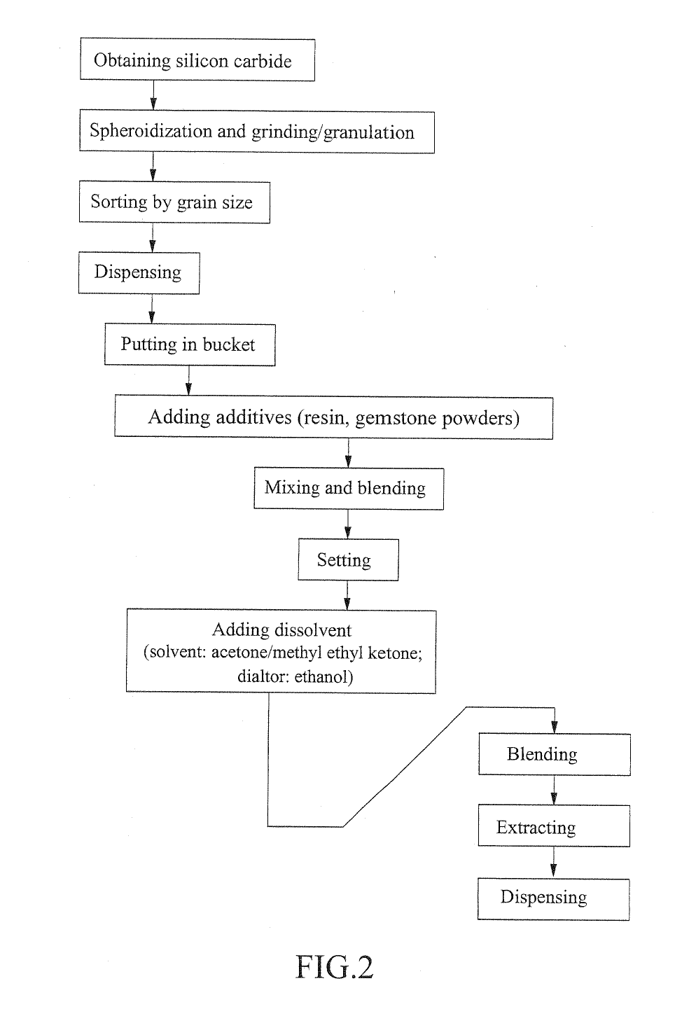

The manufacturing of the composite of the present invention could be conducted according to FIG. 2. As illustrated, after the silicon carbide is obtained, it first undergoes spheroidization and grinding/granulation, and dispensing. Then it is combined and mixed with a fixed amount of additives (teflon resin, gemstone powders). It is then blended with a fixed amount of dissolvent (acetone, methyl ethyl ketone, ethanol). Finally, it is dispensed for future application.

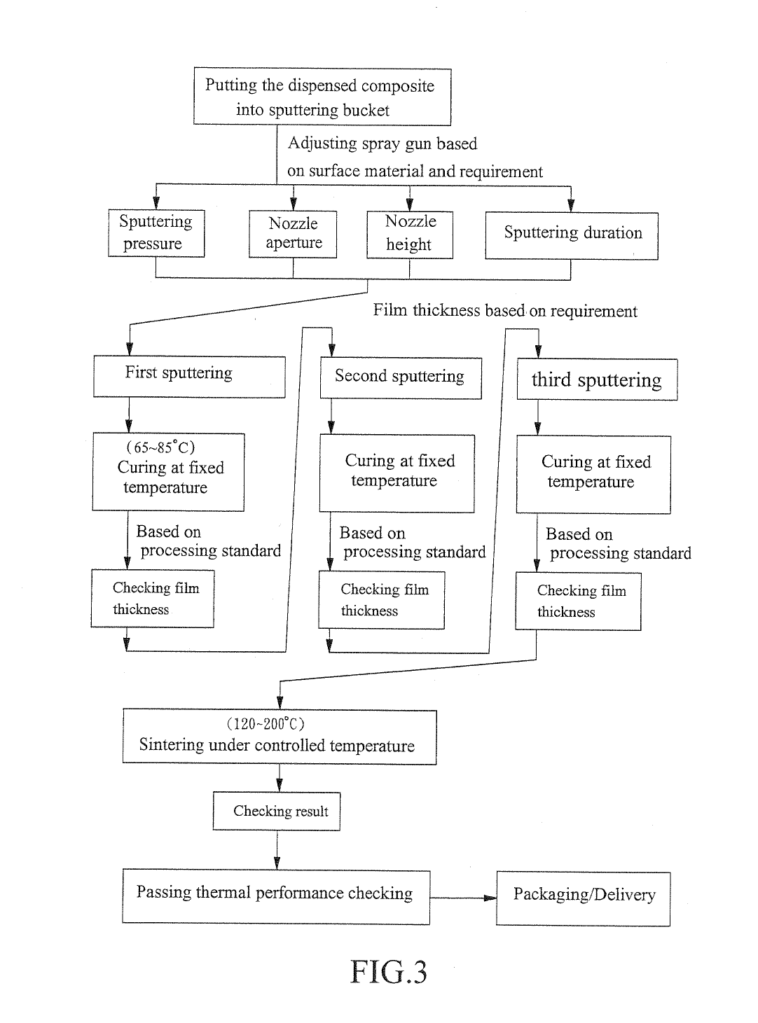

The composite's coating operation is depicted in FIG. 3. As illustrated, the composite is precisely sputtered and coated on the object to be heat-dissipated, and then cured to form a heat dissipation film. There are various types of curing, such as drying under room temperature, low- and mid-temperature sintering. The chose of curing method depends on the required film thickness and color. As the film thickness and color are also determined by the percentages of the major component and gemstone powders. These factors have to be jointly considered to determine the way of application of the composite. The working time would also vary accordingly and there is no fixed application procedure.

According to the foregoing description, the composite of the present invention, according to detailed experiments, is capable of being directly coated and sputtered on the surface of the object to be heat-dissipated, and then cured to a film of pre-determined thickness. As such, the heat-dissipating performance could be conveniently enhanced. There is no need to rely on heat-sinking fins of large surface area. The production cost is reduced, recycling is easier, and the highly contaminating anodizing treatment could be avoided, while the robustness against erosion and harsh weather is still maintained.

The following experiments have been carried out to show the heat-dissipating performance of the present invention:

### Experiment I

An aluminum plate is evenly sputtered with the composite according to the present invention and positioned beside a heat source. The temperature of the heat source is 46.4 degrees centigrade, and the room temperature is 28 degrees centigrade. The temperature difference is 18.4 (46.4−28) degrees centigrade. When it comes to an equilibrium condition, the temperature of the aluminum plate evenly sputtered with the composite according to the present invention is 42.9 degrees centigrade, while the aluminum plate without the composite is 46.4 degrees centigrade. Hence, the temperature decrease rate is around 19% (3.5/18.4). Through infrared photography, it is clear that the heat is evenly spread all over the aluminum plate.

### Experiment II

The temperature at the rear side of the aluminum plate beside the heat source is 40.6 degrees centigrade, and the room temperature is 28 degrees centigrade. When it comes to an equilibrium condition, the temperature of the aluminum plate evenly sputtered with the composite according to the present invention is 36.7 degrees centigrade, while the aluminum plate without the composite is 40.6 degrees centigrade. Hence, the temperature decrease rate is around 30.9% (3.9/12.6). Through infrared photography, it is clear that the heat is evenly spread all over the aluminum plate.

### Experiment III

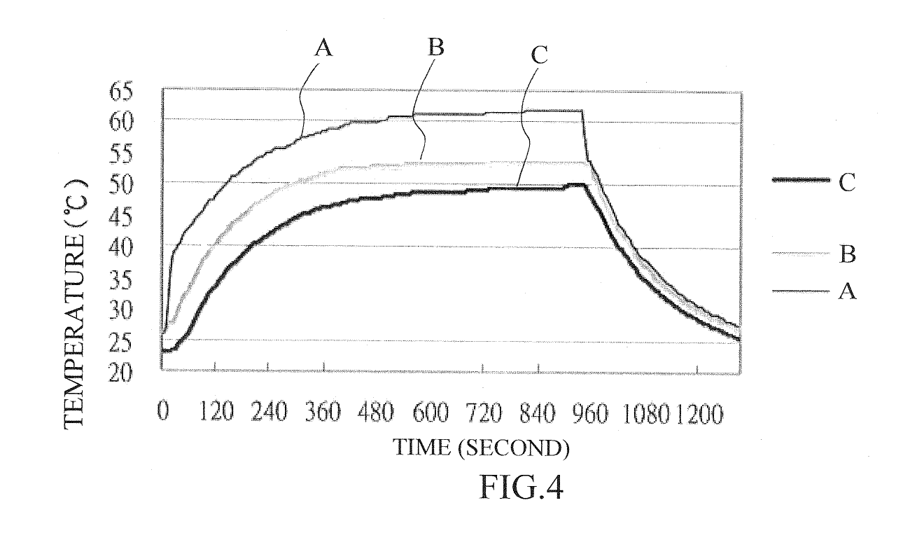

This experiment is carried out to compare the temperatures of the light source of a lamp, the inner side of the lampshade, and the inner side of the lampshade sputtered with the composite according to the present invention. As shown in FIG. 4 wherein lines A, B, C and D are obtained from the light source, the inner side of the lampshade, and inner side of the lampshade sputtered with the composite according to the present invention, respectively. It is obvious that there is a temperature decrease of 5˜7 degrees centigrade in the inner side of the lampshade sputtered with the composite according to the present invention.

### Experiment IV

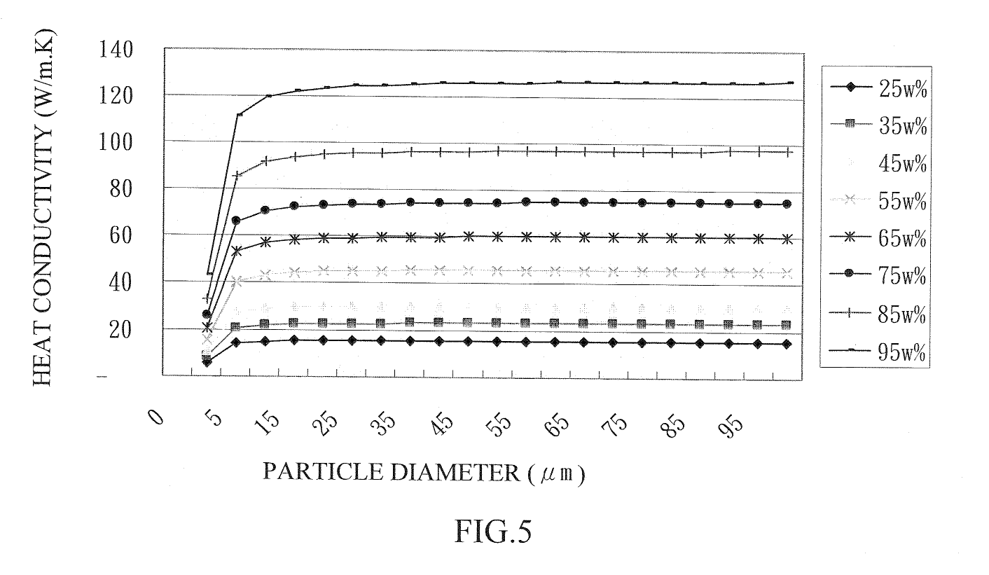

This experiment illustrates the relationship between the heat conductivity and the particle diameter of the silicon carbide according to the present invention. As shown in FIG. 5, the preferable particle diameters of the silicon carbide lie within the range of 10 μm˜50 μm.

### Experiment V

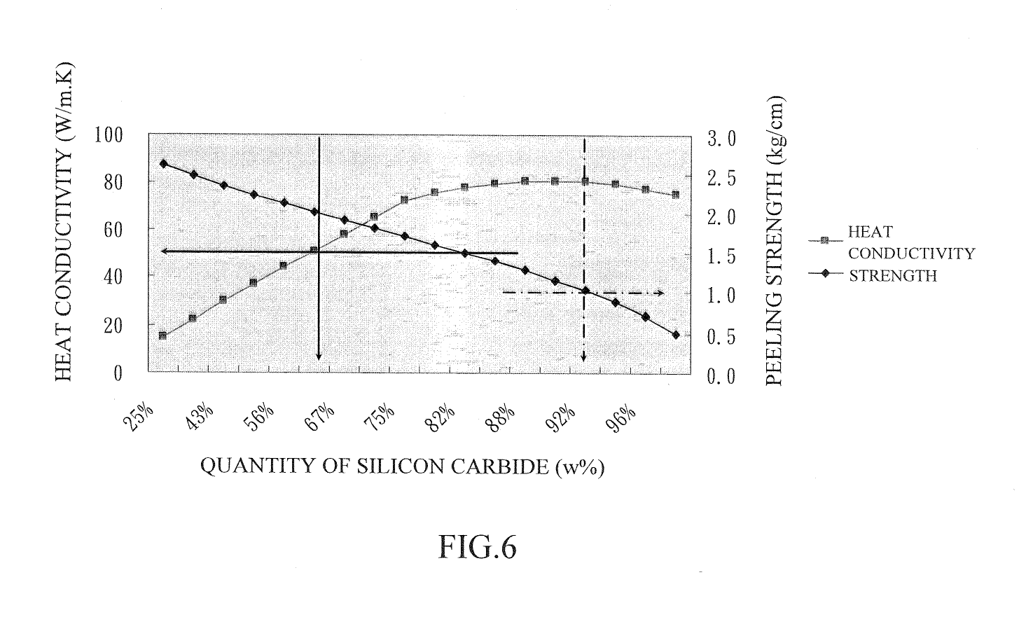

This experiment (see FIG. 6) illustrates the relationship between the heat conductivity the quantity of silicon carbide contained in the composite according to the present invention, and the peeling strength.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A composite comprising:
a silicon carbide of 67˜92 wt. % and having a particle diameter of 5 μm˜50 μm;
a powder resin of 8-33 wt. %;
wherein said silicon carbide is mixed with said resin powder, stirred well and then dried into a powder material for spraying and coating on an object to be heat-dissipated, and said powder material is diluted with a solvent into required concentration when desired to spray and coat on said object to be heat-dissipated.

2. The composite as claimed in claim 1, further comprising a dilute solvent of 60˜65 wt. %, wherein said silicon carbide, said resin and said dilute solvent are combined and blended into a material capable of being sputtered, coated, and cured into a heat-dissipating film of a pre-determined thickness on an object to be heat-dissipate, and when in use, said material is sprayed on an object to be heat-dissipated by means of a spraying gun with a nozzle having a diameter of 1˜2 mm and then heated at 150˜170 degrees for 60˜30 minutes thereby forming a heat-dissipating film of a pre-determined thickness on an object to be heat-dissipated.

3. The composite as claimed in claim 1, wherein said silicon carbide, said resin and said dilute solvent are mixed and stirred into a sputtering material which is further diluted with said dilute solvent in an amount of at least one time as much as said sputtering material, and then dried at a temperature below 100 degrees centigrade into silicon carbide particles of a diameter of 5 μm˜50 μm coated with a film of resin for sputtering.

4. The composite as claimed in claim 1, wherein said solvent is selected from acetone, methyl ethyl ketone, methanol, or ethanol.

5. The composite as claimed in claim 1, wherein said resin contains gemstone powder to achieve a specific color.

6. The composite as claimed in claim 1, wherein said resin is selected from a group of resins including acrylicresin, epoxy resin, phenolic resin and teflon resin.

7. The composite as claimed in claim 2, wherein said solvent is selected from acetone, methyl ethyl ketone, methanol, or ethanol.

8. The composite as claimed in claim 2, wherein said resin contains gemstone powder to achieve a specific color.

9. The composite as claimed in claim 2, wherein said resin is selected from a group of resins including acrylicresin, epoxy resin, phenolic resin and teflon resin.

10. The composite as claimed in claim 3, wherein said solvent is selected from acetone, methyl ethyl ketone, methanol, or ethanol.

11. The composite as claimed in claim 3, wherein said resin contains gemstone powder to achieve a specific color.

12. The composite as claimed in claim 3, wherein said resin is selected from a group of resins including acrylicresin, epoxy resin, phenolic resin and teflon resin.
